(19) United States
(12) Patent Application Publication
(10) Pub. No.: US 2025/0240753 A1
(43) Pub. Date: Jul. 24, 2025

(54) DELETION OF DUPLICATE TAC RANGES IN 5GC

(71) Applicant: T-Mobile USA, Inc., Bellevue, WA (US)

(72) Inventors: Kameswaran Arunachalam, Snohomish, WA (US); Mahesh Kuttamkulangara Vijayan, Woodinville, WA (US)

(21) Appl. No.: 18/416,656

(22) Filed: Jan. 18, 2024

(51) Int. Cl. H04W 60/04; H04W 8/12; H04W 24/02

(52) U.S. Cl. CPC H04W 60/04; H04W 8/12; H04W 24/02

(57) ABSTRACT

Described herein are techniques for removing duplicate tracking area code (TAC) ranges from multiple tracking area identity (TAI) group lists shared among a service management function (SMF), a network repository function (NRF), and an access and mobility management function (AMF), with one of the SMF, NRF, and AMF removing the duplicate TAC ranges.

### BACKGROUND

Fifth Generation (5G) networks include a core network (also referred to as a 5G core (5GC) and 5G core network) managing services and connectivity for devices connected to the 5G networks. These 5G core networks include such nodes as an access and mobility management function (AMF), a network repository function (NRF), and a service management function (SMF). These three nodes—AMF, NRF, and SMF—exchange among themselves (through the NRF) mappings of SMFs to tracking area codes (TACs)—geographic area identifiers associated with gNodeBs (gNBs)—the base stations of the 5G networks. An AMF receiving a TAC from a user equipment (UE) registering through a gNB can provide that TAC to the NRF and receive identification(s) of SMF(s) associated with TAC ranges that include the TAC code (as well as other SMF(s) for backup). The NRF receives the mappings/lists that these identifications are based on from the SMFs themselves. When these mappings/lists include incorrect or duplicate data, however, it can cause errors in the way that the 5G core network functions.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is an overview diagram of a 5G core network that includes an AMF, an NRF, and a SMF and validates and manages TAC ranges included in tracking area identity (TAI) group lists exchanged among the AMF, NRF, and SMF.

FIG. 2 is a flow diagram of an illustrative process for removing a duplicate TAC range from TAI group lists exchanged among the AMF, NRF, and SMF.

FIG. 3 is a flow diagram of an illustrative process for an NRF configured to identify a duplicate TAC range in TAI group lists provided in a SMF registration and to respond to the SMF registration with a rejection based at least in part on identifying the duplicate TAC range.

FIG. 4 is a flow diagram of an illustrative process for an SMF to determine that TAI group lists received from a source include a duplicate TAC range and to respond to that source with an error message.

FIG. 5 is a schematic diagram of a computing device capable of implementing functionality of at least one of the device(s) of the 5G core network.

### DETAILED DESCRIPTION

This disclosure is directed in part to techniques for removing duplicate TAC ranges from multiple TAI group lists shared among an SMF, an NRF, and an AMF, with one of the SMF, NRF, and AMF removing the duplicate TAC ranges.

In some examples, an AMF receiving identifications of a same TAC range in two different TAI groups with different priorities will select a TAC range and associated SMF with a lesser priority when a TAC range and SMF with a greater priority is available. For instance, the AMF may request results associated with a specific TAC code and receive identifications of multiple SMFs for that TAC code due to inclusion of the TAC code in a duplicate TAC range. The TAC range including the TAC code may appear in a first TAI group with priority ‘2’ and a second TAI group with a priority ‘5’, with ‘2’ being a greater priority and ‘5’ being a lesser priority. As a result of these operations, some SMFs may be more loaded than intended in a configuration and others less loaded, and UEs may be less likely to be assigned to the SMFs closest to them, even when those SMFs are available.

In various implementations, difficulties such as those described can be avoided by removing duplicate TAC ranges, either through filtering out those duplicate TAC ranges or by updating configurations to remove them. In some examples, the SMF can be configurated to remove the duplicate TAC range before registering with the NRF, the NRF can be configured to remove the duplicate TAC range before storing received TAI group lists or before providing results (e.g., a subset of the TAI group lists) to an AMF, or an AMF may be configured to remove the duplicate TAC range from results received from the NRF before the AMF stores those results.

In other or additional implementations, the NRF can be configured to identify a duplicate TAC range in a registration from an SMF and respond to the SMF with a rejection of the registration. Alternatively or additionally, an SMF can be configured to validate TAC ranges received from a source (e.g., as data entry or a configuration update) and can reject duplicate TAC ranges.

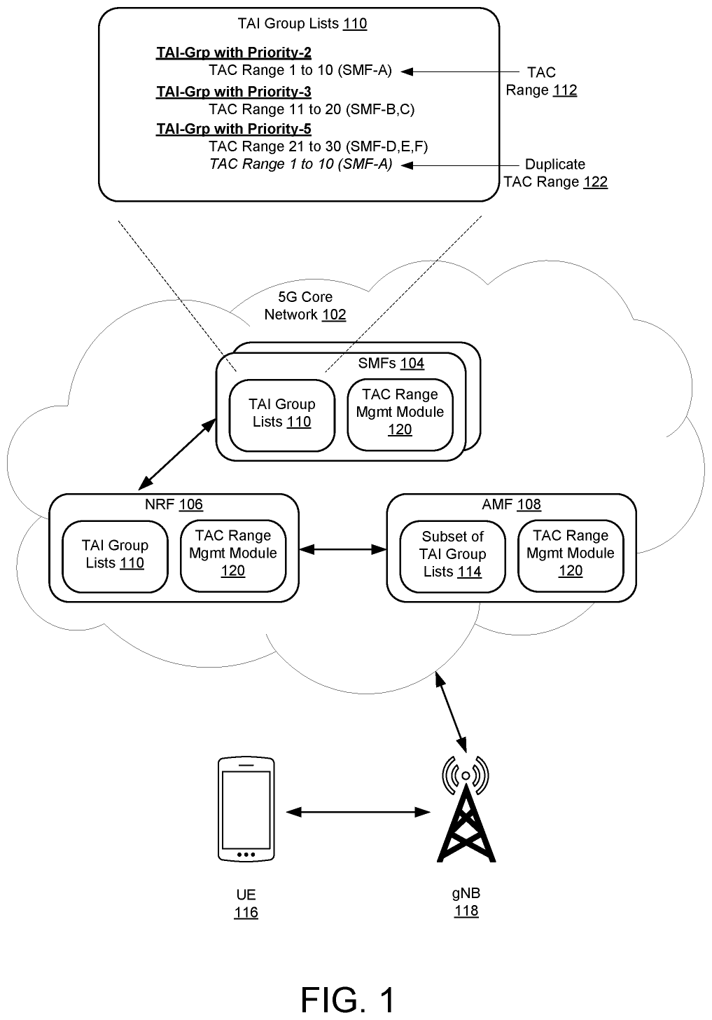

FIG. 1 is an overview diagram of a 5G core network that includes an AMF, an NRF, and a SMF and validates and manages TAC ranges included in tracking area identity (TAI) group lists exchanged among the AMF, NRF, and SMF. As illustrated, a 5G core network 102 includes SMFs 104, an NRF 106, and an AMF 108. An SMF 104 of the SMFs 104 provides its TAI group lists 110 to the NRF 106 when it registers with the NRF 106. Each TAI group list 110 may include one or more TAC ranges 112. The AMF 108 may also request a subset of the TAI group lists 114 from responsive a request from a UE 116 through a gNB 118. Also, any one or more of the SMF 104, NRF 106, and AMF 108 may include a TAC range management module 120 that is capable of validating TAC ranges 112 and removing duplicate TAC ranges 122.

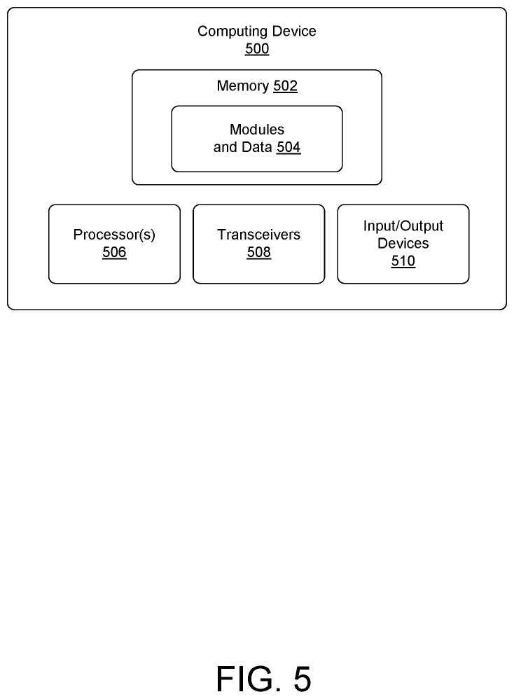

In various implementations, the 5G core network 102 is a core network of a 5G network that also includes multiple access networks, such as access networks associated with cell sites and base stations (e.g., gNB 118). The 5G core network 102 can provide identity, mobility, authentication, security, routing, charging, and other services to users of the 5G network through their UEs (e.g., UE 116). Example nodes of the 5G core network 102 include SMFs 104, NRF 106, and AMF 108, as well as a unified data management (UDM) node, a unified data register (UDR), a charging function (CHF), an authentication server function (AUSF), a policy control function (PCF), and a user plane function (UPF). This list is not exhaustive; different implementations may include other additional or different nodes. Nodes can each be implemented by a computing device; alternatively, a node can be implemented across multiple computing devices or a single computing device may implement multiple nodes. An example computing device capable of implementing node(s) of the 5G core network 102 is illustrated in FIG. 5 and described herein in greater detail with reference to that figure. Further, the 5G core network 102 can support network slicing, with a network slice including allocated resources from each of multiple nodes of the 5G core network 102 for an application/service, a UE or group of UEs, a cell site, etc.

While the disclosure herein speaks in terms of a “5G network” and “5G core network”, it is to be understood that the described techniques may apply to other generations of network technology.

As shown in FIG. 1, a gNB 118 may be connected to both the 5G core network 102 and a UE 116 to provide connectivity to the UE 116 using wireless communication and access to network services. The gNB 118 may be at a specific cell site and be part, e.g., of a radio tower or other physical structure. As such the gNB 118 may be associated with a specific location that is identified within the 5G network using a TAC code. When a UE 116 registers with the gNB 118, it receives the TAC code of the gNB 118.

In some implementations, the UE 116 may be any sort of device capable of wireless communication with a telecommunications network, such as the 5G network described herein. The UE 116 may be a cellular phone, a mobile device, a tablet computer, a personal computer (PC), a smart watch, goggles, an Internet-of-Things (IoT) device, a home Internet device, an appliance, etc. The UE 116 may connect to the 5G network through the gNB 118 and receive the TAC code of the gNB 118 as part of registering. The UE 116 may then form a local connection with the AMF 108 and provide the AMF 108 with the TAC code. The AMF 108 will then select a geographically appropriate SMF 104 to serve the UE 116 based on the TAC code.

In various implementations, an SMF 104 can register with the NRF 106 and, in doing so, provide TAI group lists 110 that are part of the configuration of the SMF 104 or stored by the SMF 104. These TAI group lists 110, as shown in FIG. 1, are each mapped to a priority and to one or more TAC ranges 112. Those TAC ranges 112 are in turn each associated with one or more SMFs 104. For example, if SMFs 104 comprise SMFs of a region that includes thirty TACs, an SMF 104 of those SMFs 104 may belong to the highest priority TAI group list 110 for the TACs in its TAC range 112, and optimal backup SMF 104 associated with a different TAC range 112 (e.g., a geographically adjacent TAC range 112) may be associated with a second priority TAI group list 110. All other TAC ranges 112 and their SMFs 104 of the region may be associated with a lowest priority TAI group list 110. In FIG. 1, the TAI group list 110 with the highest priority is the TAI group list 110 with the priority of ‘2’. The TAI group list 110 with the second priority is the TAI group list 110 with the priority of ‘3’. Lastly, the TAI group list 110 with the lowest priority is the TAI group list 110 with the priority of ‘5’.

These TAI group lists 110 may be entered by personnel of the operator of the 5G network or may be generated by logic of a node or component of the 5G network or another network of the operator. In some implementations, the TAI group lists 110 can be validated by a TAC range management module 120 of the SMF 104 receiving those TAI group lists 110. Such validation can include determining that the TAI group lists 110 include a duplicate TAC range 122. The TAC range management module 120 can then either respond by rejecting some or all of the received TAI group lists 110 or by filtering/removing the duplicate TAC range 122 from those received.

In some implementations, the TAC range management module 120 could also or instead validate the TAI group lists 110 when registering with the NRF 106. In doing so, the TAC range management module 120 can detect a duplicate TAC range 122 and filter or remove the duplicate TAC range from the registration message(s), the SMF configuration/storage, or both. The outgoing registration message(s), then, would not include the duplicate TAC range 122, regardless of what is stored or was received by the SMF 104.

In various implementations, the NRF 106 serves as a common repository for the 5G core network 102 and allows nodes of the 5G core network 102 to register and discover each other. Thus, the SMFs 104 may register with the NRF 106 and the AMF 108 may discover appropriate SMF(s) 104 for a UE 116 through the NRF 106. As described herein, each SMF 104 may register its TAI group lists 110 with the NRF 106, and the AMF 108, upon connection with a UE 116, requests identification of SMF(s) 104 appropriate for a TAC code. The NRF 106 in turn provides at least a subset of the TAI group lists 114 to enable the AMF 108 to select an SMF 104 for the UE 116 based on priorities of the TAI group lists 110 and the TAC range(s) 112 associated with them.

The NRF 106 may also include a TAC range management module 120 to validate TAI group lists 110 and remove duplicate TAC ranges 122 from the TAI group lists 110. The TAC range management module 120 may filter the duplicate TAC ranges 122 from the TAI group lists 110 upon receiving them and before storing. Alternatively or additionally, the TAC range management module 120 can remove the duplicate TAC ranges 122 from the stored TAI group lists 110. Further, alternatively or additionally, the TAC range management module 120 may filter the duplicate TAC ranges 122 from the subset of TAI group lists 114 provided to the AMF 108.

In further implementations, the AMF 108 forms logical connections with UEs, such as UE 116, and discovers resources of the 5G core network 102 for the UE 116, such as an SMF 104 and one or more backup SMFs 104. To accomplish this, the AMF 108 provides the TAC code received from the UE 116 to the NRF 106 and receives, in response, a subset of the TAI group lists 114 stored by the NRF 106 that are selected based on their inclusion of the TAC code in their associated TAC ranges 112 (or inclusion of adjacent TAC ranges 112). The AMF 108 then selects an SMF 104 for the UE 116 based on the priorities of the subset of the TAI group lists 114.

The AMF 108 may also be configured with a TAC range management module 120 to validate the subset of TAI group lists 114 it has received. If a duplicate TAC range 122 is identified, it is removed by the TAC range management module 120, either by filtering it out from the receives subset of TAI group lists 114 or by deleting it prior to storage of the subset of TAI group lists 114.

While FIG. 1 shows each of the SMFs 104, NRF 106, and AMF 108 having a TAC range management module 120, it is to be understood that in some implementations, only one or two of these three node types may have a TAC range management module 120. Also, in some implementations, some but not all SMFs 104 may have a TAC range management module 120 and others of the NRF 106 and AMF 108 may have a TAC range management module 120. Further, while a same term—TAC range management module 120—is used for purposes of description and illustration, the TAC range management module 120 may perform different operations for different node types, as has been described herein.

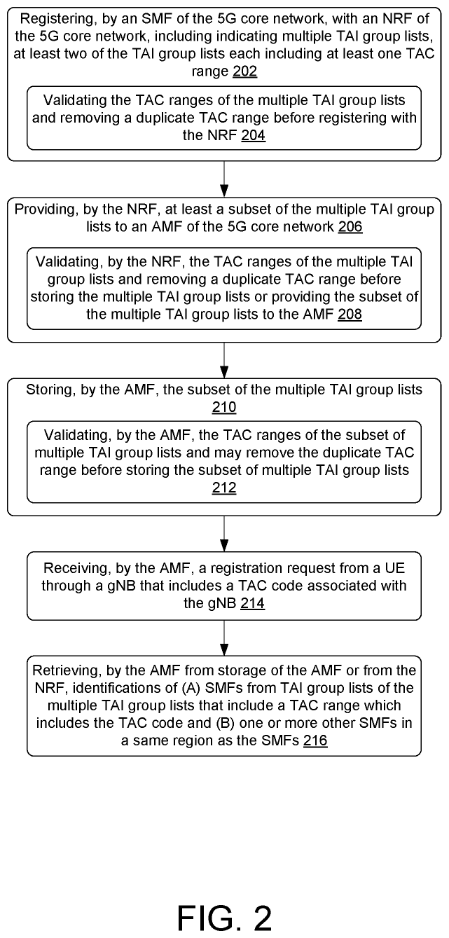

FIGS. 2-4 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 2 is a flow diagram of an illustrative process for removing a duplicate TAC range from TAI group lists exchanged among the AMF, NRF, and SMF. As illustrated at 202, an SMF of the 5G core network registers with an NRF of the 5G core network. The registering includes indicating multiple TAI group lists, at least two of the TAI group lists each including at least one TAC range. At 204, the SMF may validate the TAC ranges of the multiple TAI group lists and remove a duplicate TAC range before registering with the NRF. The removing may comprise one of filtering the duplicate TAC range from a message or deleting the duplicate TAC range from a list stored on a device.

In various implementations, the multiple TAI group lists may include at least a first TAI group list with a first priority for a first TAC range mapped to the SMF as a local SMF and a second TAI group list with a second priority that is lower than the first priority for a second TAC range mapped to a backup SMF different from the SMF. Also, the multiple TAI group lists may include a third TAI group list with a third priority that is lower than the second priority for a third TAC range mapped to other SMFs in a same region as the SMF and the backup SMF. At least one of the first TAI group list, the second TAI group list, and the third TAI group list may include the duplicate TAC range.

At 206, the NRF, provides at least a subset of the multiple TAI group lists to an AMF of the 5G core network. At 208, the NRF may validate the TAC ranges of the multiple TAI group lists and remove a duplicate TAC range before storing the multiple TAI group lists or providing the subset of the multiple TAI group lists to the AMF. The removing may comprise one of filtering the duplicate TAC range from a message or deleting the duplicate TAC range from a list stored on a device. The removing at 208 may be performed when the SMF does not validate and remove duplicate TAC ranges or may be perform regardless of whether the SMF validates and removes duplicate TAC ranges.

At 210, the AMF stores the subset of the multiple TAI group lists. At 212, the AMF may validate the TAC ranges of the subset of multiple TAI group lists and may remove the duplicate TAC range before storing the subset of multiple TAI group lists. The removing may comprise one of filtering the duplicate TAC range from a message or deleting the duplicate TAC range from a list stored on a device. The removing at 212 may be performed when the NRF and SMF do not validate and remove duplicate TAC ranges or may be perform regardless of whether the NRF and SMF validate and remove duplicate TAC ranges.

As described, one of the SMF, the NRF, and the AMF removes a duplicate TAC range from multiple TAI group lists before the AMF stores the subset of the multiple TAI group lists, at 210. The duplicate TAC range may be caused by data entry error or configuration error.

At 214, the AMF may receive a registration request from a UE through a gNB that includes a TAC code associated with the gNB.

At 216, the AMF may retrieve, from storage of the AMF or from the NRF, identifications of (A) SMFs from TAI group lists of the multiple TAI group lists that include a TAC range which includes the TAC code and (B) one or more other SMFs in a same region as the SMFs.

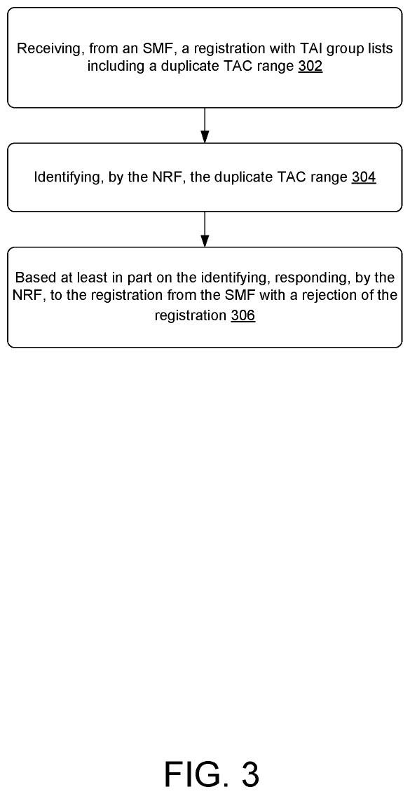

FIG. 3 is a flow diagram of an illustrative process for an NRF configured to identify a duplicate TAC range in TAI group lists provided in a SMF registration and to respond to the SMF registration with a rejection based at least in part on identifying the duplicate TAC range. As illustrated at 302, an NRF receives, from an SMF, a registration with TAI group lists including a duplicate TAC range. In some implementations, the TAI group lists may include at least a first TAI group list with a first priority for a first TAC range mapped to the SMF as a local SMF and a second TAI group list with a second priority that is lower than the first priority for a second TAC range mapped to a backup SMF different from the SMF. Also, the TAI group lists may include a third TAI group list with a third priority that is lower than the second priority for a third TAC range mapped to other SMFs in a same region as the SMF and the backup SMF. At least one of the first TAI group list, the second TAI group list, and the third TAI group list may include the duplicate TAC range.

At 304, the NRF identifies the duplicate TAC range.

At 306, based at least in part on the identifying, the NRF responds to the registration from the SMF with a rejection of the registration. The rejection may include a code identifying the duplicate TAC range as a reason for the rejection.

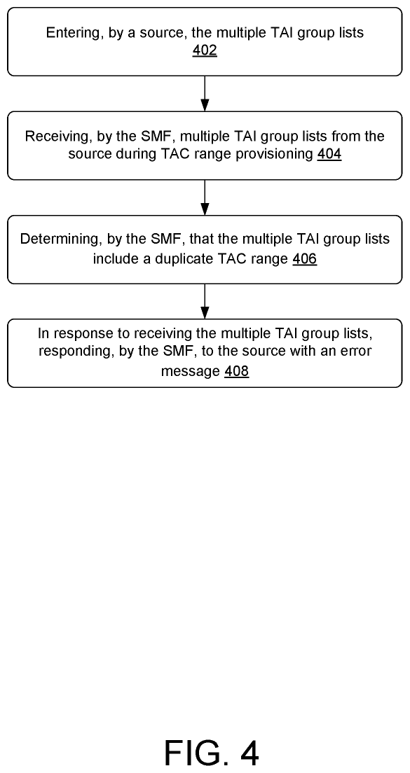

FIG. 4 is a flow diagram of an illustrative process for an SMF to determine that TAI group lists received from a source include a duplicate TAC range and to respond to that source with an error message. As illustrated at 402, a source, such as personnel of the operator of the telecommunications network, enters the multiple TAI group lists. Alternatively, the source may be a software component of the 5G network or associated with the 5G network that has the effect of updating at least one TAI group list of the TAI group lists of an SMF.

At 404, the SMF receives multiple TAI group lists from the source during TAC range provisioning. The multiple TAI group lists may include at least a first TAI group list with a first priority for a first TAC range mapped to the SMF as a local SMF and a second TAI group list with a second priority that is lower than the first priority for a second TAC range mapped to a backup SMF different from the SMF. The multiple TAI group lists may also include a third TAI group list with a third priority that is lower than the second priority for a third TAC range mapped to other SMFs in a same region as the SMF and the backup SMF.

At 406, the SMF determines that the multiple TAI group lists include a duplicate TAC range. In some implementations, at least one of the first TAI group list, the second TAI group list, and the third TAI group list may include the duplicate TAC range.

At 408, in response to receiving the multiple TAI group lists, the SMF responds to the source with an error message.

FIG. 5 is a schematic diagram of a computing device 500 capable of implementing functionality of at least one of the device(s) of the telecommunications network, such as the SMF 104, the NRF 106, and/or the AMF 108. As shown, the computing device 500 includes a memory 502 storing modules and data 504, processor(s) 506, transceivers 508, and input/output devices 510.

In various examples, the memory 502 can include system memory, which may be volatile (such as RAM), non-volatile (such as ROM, flash memory, etc.) or some combination of the two. The memory 502 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 502 can include one or more software or firmware elements, such as computer-readable instructions that are executable by the one or more processors 506. For example, the memory 502 can store computer-executable instructions associated with modules and data 504. The modules and data 504 can include a platform, operating system, and applications, and data utilized by the platform, operating system, and applications. Further, the modules and data 504 can implement any of the functionality for the SMFs 104, NRF 106, AMF 108, or any other node/device described and illustrated herein.

In various examples, the processor(s) 506 can be a central processing unit (CPU), a graphics processing unit (GPU), or both CPU and GPU, or any other type of processing unit. Each of the one or more processor(s) 506 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 506 may also be responsible for executing all computer applications stored in the memory 502, which can be associated with types of volatile (RAM) and/or nonvolatile (ROM) memory.

The transceivers 508 can include modems, interfaces, antennas, Ethernet ports, cable interface components, and/or other components that perform or assist in exchanging wireless communications, wired communications, or both.

While the computing device need not include input/output devices 510, in some implementations it may include one, some, or all of these. For example, the input/output devices 510 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 510 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 510 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

What is claimed is:

1. A method implemented in a Fifth Generation (5G) core network, the method comprising:
registering, by a session management function (SMF) of the 5G core network with a network repository function (NRF) of the 5G core network, the registering including indicating multiple tracking area identity (TAI) group lists, at least two of the TAI group lists each including at least one tracking area code (TAC) range;
providing, by the NRF, at least a subset of the multiple TAI group lists, to an access and mobility management function (AMF); and
storing, by the AMF, the subset of the multiple TAI group lists,
wherein one of the SMF, the NRF, and the AMF removes a duplicate TAC range from multiple TAI group lists before the AMF stores the subset of the multiple TAI group lists.

2. The method of claim 1, wherein the SMF validates the TAC ranges of the multiple TAI group lists and removes the duplicate TAC range before registering with the NRF.

3. The method of claim 1, wherein the NRF validates the TAC ranges of the multiple TAI group lists and removes the duplicate TAC range before storing the multiple TAI group lists or providing the subset of the multiple TAI group lists to the AMF.

4. The method of claim 1, wherein the AMF validates the TAC ranges of the subset of multiple TAI group lists and removes the duplicate TAC range before storing the subset of multiple TAI group lists.

5. The method of claim 1, wherein the multiple TAI group lists include at least a first TAI group list with a first priority for a first TAC range mapped to the SMF as a local SMF and a second TAI group list with a second priority that is lower than the first priority for a second TAC range mapped to a backup SMF different from the SMF.

6. The method of claim 5, wherein the multiple TAI group lists also include a third TAI group list with a third priority that is lower than the second priority for a third TAC range mapped to other SMFs in a same region as the SMF and the backup SMF.

7. The method of claim 6, wherein at least one of the first TAI group list, the second TAI group list, and the third TAI group list includes the duplicate TAC range.

8. The method of claim 1, further comprising:
receiving, by the AMF, a registration request from a user equipment (UE) through a gNodeB (gNB) that includes a TAC code associated with the gNB; and
retrieving, by the AMF from storage of the AMF or from the NRF, identifications of (A) SMFs from TAI group lists of the multiple TAI group lists that include a TAC range which includes the TAC code and (B) one or more other SMFs in a same region as the SMFs.

9. The method of claim 1, wherein the removing comprises one of filtering the duplicate TAC range from a message or deleting the duplicate TAC range from a list stored on a device.

10. The method of claim 1, wherein the duplicate TAC range is caused by data entry error or configuration error.

11. A network repository function (NRF) comprising:
one or more processors; and
a plurality of programming instructions executable by the one or more processors to perform operations including:
receiving, from a service management function (SMF), a registration with tracking area identity (TAI) group lists including a duplicate tracking area code (TAC) range;
identifying the duplicate TAC range; and
based at least in part on the identifying, responding to the registration from the SMF with a rejection of the registration.

12. The NRF of claim 11, wherein the rejection includes a code identifying the duplicate TAC range as a reason for the rejection.

13. The NRF of claim 11, wherein the TAI group lists include at least a first TAI group list with a first priority for a first TAC range mapped to the SMF as a local SMF and a second TAI group list with a second priority that is lower than the first priority for a second TAC range mapped to a backup SMF different from the SMF.

14. The NRF of claim 13, wherein the TAI group lists also include a third TAI group list with a third priority that is lower than the second priority for a third TAC range mapped to other SMFs in a same region as the SMF and the backup SMF.

15. The NRF of claim 14, wherein at least one of the first TAI group list, the second TAI group list, and the third TAI group list includes the duplicate TAC range.

16. A non-transitory computer storage medium having a plurality of programming instructions stored thereon that, when executed by one or more processors of a service management function (SMF) cause the SMF to perform operations comprising:
receiving multiple tracking area identity (TAI) group lists at the SMF during tracking area code (TAC) range provisioning;
determining that the multiple TAI group lists include a duplicate TAC range; and
responding to receiving the multiple TAI group lists, to a source that provided the multiple TAI group lists, with an error message.

17. The non-transitory computer storage medium of claim 16, wherein the source enters the multiple TAI group lists.

18. The non-transitory computer storage medium of claim 16, wherein the multiple TAI group lists include at least a first TAI group list with a first priority for a first TAC range mapped to the SMF as a local SMF and a second TAI group list with a second priority that is lower than the first priority for a second TAC range mapped to a backup SMF different from the SMF.

19. The non-transitory computer storage medium of claim 18, wherein the multiple TAI group lists also include a third TAI group list with a third priority that is lower than the second priority for a third TAC range mapped to other SMFs in a same region as the SMF and the backup SMF.

20. The non-transitory computer storage medium of claim 19, wherein at least one of the first TAI group list, the second TAI group list, and the third TAI group list includes the duplicate TAC range.
